(19) United States
(12) Patent Application Publication
(10) Pub. No.: US 2017/0205961 A1
(43) Pub. Date: Jul. 20, 2017

(54) TOUCH DISPLAY SYSTEM AND TOUCH CONTROL METHOD THEREOF

(71) Applicant: Coretronic Corporation, Hsin-Chu (TW)

(72) Inventors: Yung-Chih Chen, Hsin-Chu (TW); Je-Fu Cheng, Hsin-Chu (TW)

(73) Assignee: Coretronic Corporation, Hsin-Chu (TW)

(21) Appl. No.: 15/406,794

(22) Filed: Jan. 16, 2017

(30) Foreign Application Priority Data
Jan. 18, 2016 (CN) 201610031114.1

(51) Int. Cl. G06F 3/042; G06F 3/038; G06F 3/041

(52) U.S. Cl. CPC G06F 3/0421; G06F 3/0416; G06F 3/0383

(57) ABSTRACT

A touch display system and its touch control method are provided. According to a light spot detected when an invisible light curtain is turned on and off, whether the light spot is a reflected light spot generated by a touch object through reflecting the invisible light curtain or/and a self-luminous light spot generated by the touch object is determined. When the invisible light curtain is continuously turned on, the light spot captured by a light detection unit is ignored. After the invisible light curtain is turned off, the light spot is detected. When the light detection unit starts to detect the light spot, if the invisible light curtain is already turned off, the light spot is directly detected. It is likely to effectively distinguish whether the detected light spot is generated by a non-self-luminous or self-luminous touch object, and applicability of the touch display system is further enhanced.

### CROSS-REFERENCE TO RELATED APPLICATION

This application claims the priority benefit of China application serial no. 201610031114.1, filed on Jan. 18, 2016. The entirety of the above-mentioned patent application is hereby incorporated by reference herein and made a part of this specification.

### BACKGROUND OF THE INVENTION

Field of the Invention

The invention relates to a touch apparatus; more particularly, the invention relates to a touch display system and a touch control method thereof.

Description of Related Art

According to the conventional optical touch control technology, a light source and an optical sensor are arranged on the edge of a screen; through scanning the touch area by light emitted from the light source and the optical sensor senses partial light reflected or blocked by the touch object, the touch location can be determined according to the sensing result of the optical sensor. The known optical touch control technology allows the location of the light spot generated by the reflection or blocking of the touch object to be effectively determined; however, if the self-luminous touch object and the non-self-luminous touch object are used simultaneously, it is unlikely to effectively determine whether the detected light spot is generated by the self-luminous touch object or the non-self-luminous touch object according to the known optical touch technology.

The information disclosed in this “BACKGROUND” section is only for enhancement of understanding of the background of the described technology and therefore it may contain information that does not form the prior art that is already known to a person of ordinary skill in the art. Further, the information disclosed in this “BACKGROUND” section does not mean that one or more problems to be resolved by one or more embodiments of the invention was acknowledged by a person of ordinary skill in the art.

### SUMMARY OF THE INVENTION

The invention provides a touch display system and a touch control method thereof for effectively distinguishing whether a detected light spot is generated by a non-self-luminous touch object or by a self-luminous touch object, and the applicability of the touch display system can be further enhanced.

Other objects and advantages of the invention can be further illustrated by the technical features broadly embodied and described as follows.

In order to achieve one or a portion of or all of the objects or other objects, an embodiment of the invention provides a touch display system that includes a display apparatus, an invisible light generating unit, a light detection unit, and a host. The display apparatus provides a display image. The invisible light generating unit generates an invisible light curtain, and the invisible light curtain is parallel to the display image and covers the display image, so as to form a touch area. The light detection unit is coupled to the invisible light generating unit, captures an image of the touch area, detects at least one light spot in the touch area, and determines whether the at least one light spot in the touch area is a reflected light spot generated by a touch object through reflecting the invisible light curtain or/and a self-luminous light spot generated by the touch object according to the at least one light spot detected in the touch area when the invisible light curtain is turned on and turned off. The host is coupled to the light detection unit and determines a touch location of the touch object on the display image according to the at least one light spot detected in the touch area by the light detection unit. If the invisible light curtain is continuously turned on, the at least one light spot located in the touch area and captured by the light detection unit is ignored, and after the turned-on invisible light curtain is turned off, the host performs a determination on the at least one light spot located in the touch area captured by the light detection unit.

Another embodiment of the invention provides a touch control method of a touch display system, and the touch control method includes following steps. A display image is provided. An invisible light curtain is generated to form a touch area, wherein the invisible light curtain is parallel to the display image and covers the display image. An image of the touch area is captured by the light detection unit, and at least one light spot in the touch area is detected by the light detection unit. Whether the at least one light spot in the touch area is a reflected light spot generated by a touch object through reflecting the invisible light curtain or/and a self-luminous light spot generated by the touch object is determined according to the at least one light spot detected in the touch area when the invisible light curtain is turned on and turned off. A touch location of the touch object is determined according to the at least one light spot in the touch area captured by the light detection unit. If the invisible light curtain is continuously turned on, the at least one light spot located in the touch area and captured by the light detection unit is ignored, and after the turned-on invisible light curtain is turned off, the host performs a determination on the at least one light spot located in the touch area captured by the light detection unit.

In view of the above, the light spot in the touch area in the image is detected when the invisible light curtain is turned on and turned off, and whether the light spot in the touch area is the reflected light spot generated by the touch object through reflecting the invisible light curtain or/and the self-luminous light spot generated by the touch object is determined. When the invisible light curtain is continuously turned on, the light spot that is located in the touch area and captured by the light detection unit is ignored. After the invisible light curtain is turned off, the light spot located in the touch area in the image and captured by the light detection unit is determined. When the light detection unit starts to detect the light spot, if the invisible light curtain is already turned off, the light spot in the touch area is directly determined. Thereby, whether the detected light spot is generated by the non-self-luminous touch object or by the self-luminous touch object can be effectively determined, and the applicability of the touch display system can be further enhanced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a touch display system according to an embodiment of the invention.

FIG. 2 is a schematic diagram illustrating the captured images corresponding to an invisible light curtain which is turned on and turned off according to an embodiment of the invention.

FIG. 3 is a schematic sequence diagram of capturing an image of a touch area by a light detection unit according to an embodiment of the invention.

FIG. 4 is a schematic flow chart illustrating a touch control method of a touch display system according to an embodiment of the invention.

FIG. 5 is a schematic flow chart illustrating a touch control method of a touch display system according to another embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

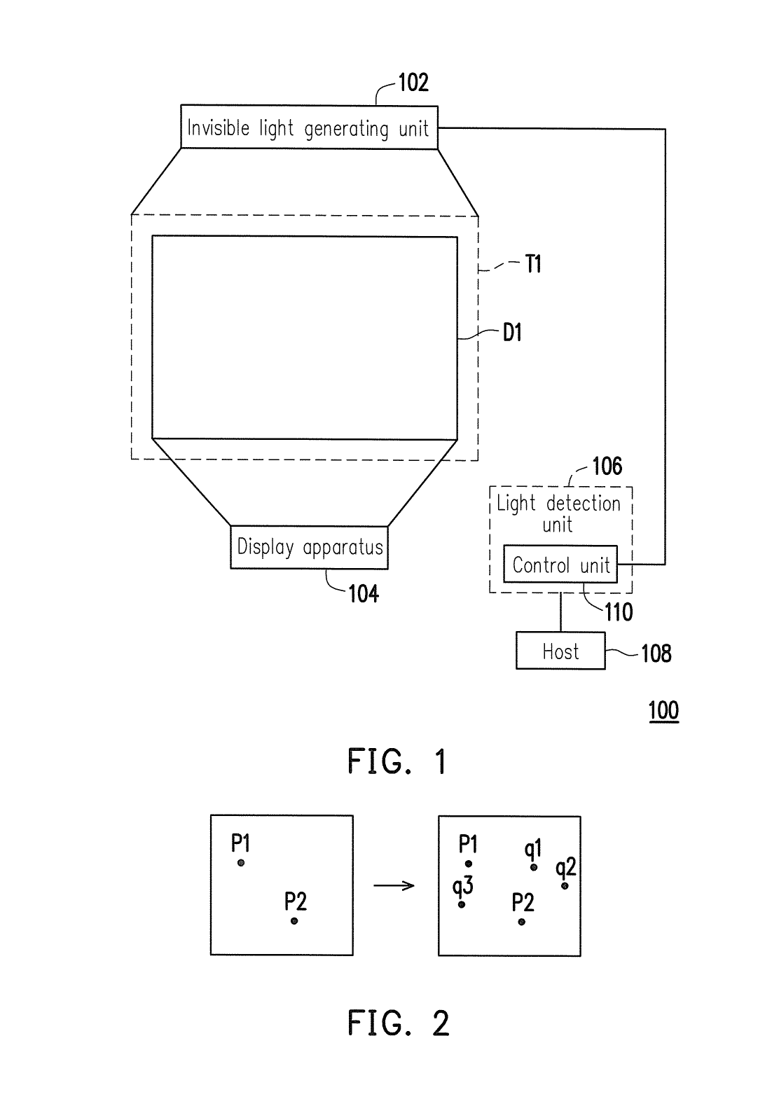

FIG. 1 is a schematic diagram illustrating a touch display system according to an embodiment of the invention. As shown in FIG. 1, the touch display system 100 includes an invisible light generating unit 102, a display apparatus 104, a light detection unit 106, and a host 108. The light detection unit 106 is coupled to the invisible light generating unit 102 and the host 108. In an embodiment of the invention, the host 108 and the light detection unit 106 are integrated as one apparatus, for instance; in another embodiment of the invention, the light detection unit 106 is coupled to the invisible light generating unit 102 and the display apparatus 104, and the display apparatus 104 and the light detection unit 106 are integrated as one apparatus (not shown), for instance. However, the invention is not limited thereto. The display apparatus 104 can provide a display image D1. In the embodiment, the display apparatus 104 is a projector, and the display image D1 is a projected image. The display image D1 is transmitted in a wireless manner or through a cable from the host 108 or another image source, e.g., a flash drive or a U-drive, which should not be construed as a limitation to the invention. In another embodiment of the invention, the display apparatus 104 can also be a liquid crystal display (LCD), for instance. The invisible light generating unit 102 generates an invisible light curtain, and the invisible light curtain is parallel to the display image D1 and covers the entire display image D1, so as to form a touch area T1. As shown in FIG. 1, the touch area T1 is greater than the display image D1, which should however not be construed as a limitation to the invention; in another embodiment of the invention, the touch area T1 can also be equal to or smaller than the display image D1.

The light detection unit 106 can be an infrared camera, an infrared camcorder or any other videotaping apparatus capable of detecting invisible light, for instance, and the light detection unit 106 is configured to detect the invisible light, capture the image of the touch area T1, and detect the light spot in the touch area T1. According to the detected light spot in the touch area T1 during the on/off of the invisible light curtain, the light detection unit 106 determines whether the light spot in the captured image is a reflected light spot generated by a touch object through reflecting the invisible light curtain or/and a self-luminous light spot generated by the touch object. Here, the non-self-luminous touch object may be a finger, a stylus, or any other object capable of reflecting the invisible light curtain, for instance, and the self-luminous touch object may be an invisible laser pen capable of generating the self-luminous light spot (i.e., the invisible light spot), for instance. Note that when the light detection unit 106 starts to capture the image of the touch area T1, if the invisible light curtain is continuously turned on, the light spot located in the touch area T1 and captured by the light detection unit 106 is ignored, and after the turned-on invisible light curtain is turned off, the light spot located in the touch area T1 and captured by the light detection unit 106 is determined. If the invisible light curtain is already turned off (at the time of capturing the image of the touch area T1), the light spot in the touch area T1 is directly determined.

FIG. 2 is a schematic diagram illustrating the captured images corresponding to an invisible light curtain which is turned on and turned off according to an embodiment of the invention. In FIG.2, the left image shows the image captured by the light detection unit 106 (shown in FIG. 1) while the invisible light generating unit 102 (shown in FIG. 1) is turned off and does not generate any invisible light curtain, and light spots P1 and P2 are shown in the touch area T1 (shown in FIG. 1) in the captured image. And the right image shows the image captured by the light detection unit 106 (shown in FIG. 1) while the invisible light generating unit 102 (shown in FIG. 1) is turned on and generates the invisible light curtain, and light spots P1, P2, q1, q2, and q3 are shown in the touch area T1 (shown in FIG. 1) in the captured image. After comparing the left image with the right image in FIG. 2, it can be learned that the light spots P1 and P2 appear in the captured image no matter when the invisible light curtain is turned on or turned off, and thus the light spots P1 and P2 are generated from the self-luminous touch object. By contrast, the light spots q1, q2, and q3 merely appear in the captured image when the invisible light curtain is turned on, and thus the light spots q1, q2, and q3 are generated from the non-self-luminous touch object.

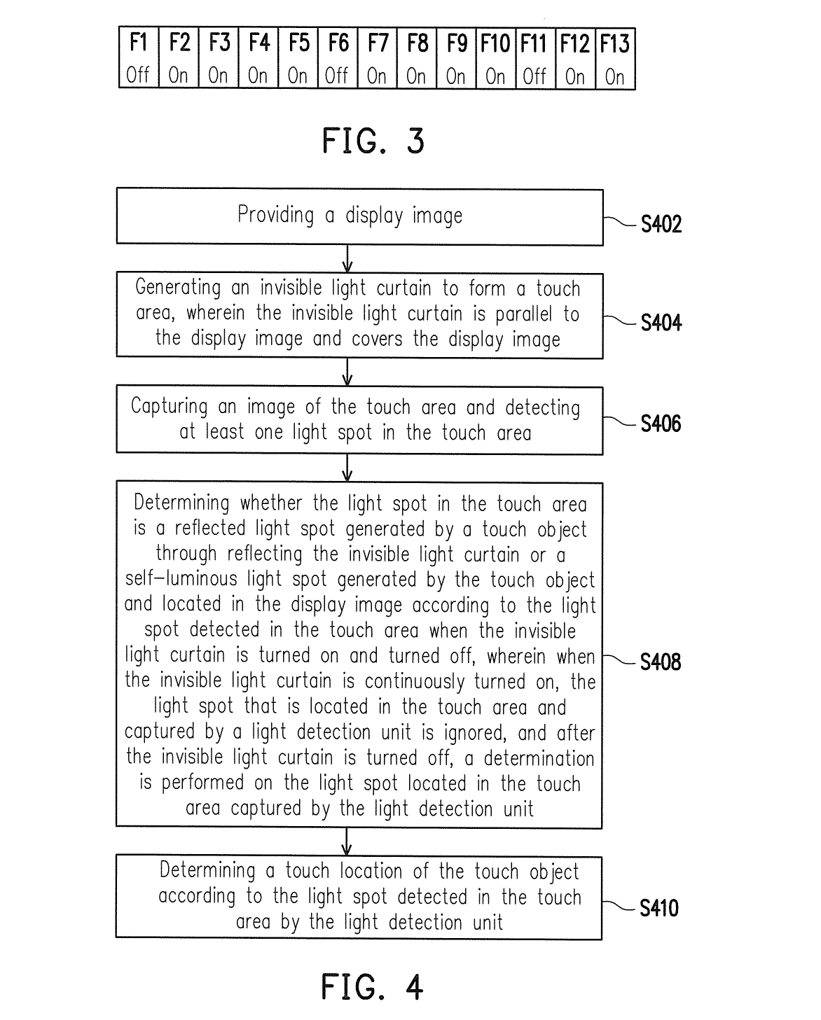

With reference to FIG. 1, a frequency of turning on and off the invisible light curtain and an image capturing frequency of the light detection unit 106 can be controlled by the control unit 110 of the light detection unit 106. The control unit 110 is coupled to the invisible light generating unit 102 and may include a counter, for instance; however, the invention is not limited thereto. Besides, in an embodiment of the invention, the control unit 110 can be arranged outside the light detection unit 106 and is coupled to the invisible light generating unit 102 and the light detection unit 106. When the invisible light generating unit 102 is turned off and does not generate any invisible light curtain (i.e., when the invisible light curtain is turned off), the light detection unit 106 can capture one image of the touch area T1 according to the image capturing frequency predetermined by the control unit 110. When the invisible light generating unit 102 is turned on and generates the invisible light curtain (i.e., when the invisible light curtain is turned on), the light detection unit 106 can continuously capture plural images of the touch area T1 according to the image capturing frequency predetermined by the control unit 110. According to the comparison between the single image captured when the invisible light curtain is turned off and the plural images captured when the invisible light curtain is turned on, the type of the touch object generating the light spot in the touch area T1 can be determined. FIG. 3 is a schematic sequence diagram of capturing an image of a touch area by a light detection unit according to an embodiment of the invention. With reference to FIG. 1 and FIG. 3, FIG. 3 shows the successive images F1-F13 which can represent the state of the invisible light generating unit 102 when the light detection unit 106 captures each image frame. Here, the frequency of turning on and off the invisible light curtain corresponds to the image capturing frequency of the light detection unit 106. When the light detection unit 106 starts to detect the light spot, and if the invisible light generating unit 102 is turned off and does not generate any invisible light curtain, the light detection unit 106 captures a first image frame F1 in the touch area T1; when the light detection unit 106 again captures a second image frame F2, the invisible light generating unit 102 is turned on and generates the invisible light curtain.

The rest can be deduced from the above. According to the embodiment shown in FIG. 1 and FIG. 3, during the period of capturing the second image frame F2 to the fifth image frame F5, the period of capturing the seventh image frame F7 to the tenth image frame F10, and the period of capturing the twelfth image frame F12 and the thirteenth image frame F13 by the light detection unit 106, the invisible light generating unit 102 is continuously turned on; during the periods of capturing the first image frame F1, the sixth image frame F6, and the eleventh image frame F11 by the light detection unit 106, the invisible light generating unit 102 is turned off. However, the actual application is not limited to those provided above. Specifically, in other embodiments of the invention, the frequency of turning off the invisible light generating unit 106 may be higher or lower than the frequency provided herein, i.e., the number of the images of the touch area T1 which are continuously captured by the light detection unit 106 is not limited to what is shown in FIGS. 3, and 13 image frames provided in the embodiment are merely explanatory and should not be construed as a limitation to the invention.

With reference to FIG. 1, the control unit 110 is coupled to the light detection unit 106 and can include a processor, for instance, so as to determine the touch location of the touch object on the display image D1 according to the light spot located in the touch area T1 and detected by the light detection unit 106 and transmit the information of the touch location back to the host 108; however, the invention is not limited thereto. According to another embodiment of the invention, the host 108 can determine the touch location of the touch object on the display image D1 according to the light spot located in the touch area T1 and detected by the light detection unit 106; in addition, the host 108 can also define the function of the touch object according to whether the touch object is configured to generate the reflected light spot or/and the self-luminous light spot. For instance, if it is determined that the touch area T1 has the touch object that can generate the self-luminous light spot, the touch object is defined to have the function of a painting brush; if it is determined that the touch area T1 has the touch object that can generate the rejected light spot, the touch object is defined to have the function of an eraser.

If the invisible light curtain is continuously turned on, the light spot that is located in the touch area T1 and captured by the light detection unit 106 is ignored, and after the turned-on invisible light curtain is turned off, the light spot that is located in the touch area T1 and captured by the light detection unit 106 is determined. If the invisible light curtain is already turned off at the time of capturing the image of the touch area T1 by the light detection unit 106, the light spot in the touch area T1 is directly determined. At the very beginning, the host 108 may set up the function of the touch object which generates the reflected light spot and the function of the touch object which generates the self-luminous light spot, such that the user may intuitively perform a writing action and erasing the written contents in the touch area T1 with use of the touch objects with different functions. It should be mentioned that the functions of the touch objects (e.g., generating the reflected light spot and the self-luminous light spot) as defined in the embodiment are merely exemplary and should not be limited herein; in another embodiment, the function of the touch object can be defined in a different manner, e.g., the function of controlling image broadcast (for example, starting to broadcast images or temporarily suspending the image broadcast).

Thereby, the light spot in the touch area T1 is detected according to the predetermined frequency of turning on or turning off the invisible light curtain, and the light detection unit 106 captures the image of the touch area T1 according to the corresponding image capturing frequency and further determines whether the light spot in the touch area T1 is the reflected light spot generated by the touch object through reflecting the invisible light curtain or/and the self-luminous light spot generated by the touch object, so as to effectively determine whether the detected light spot is generated from the non-self-luminous touch object or from the self-luminous touch object and define the function of the touch object according to whether the touch object is configured to generate the reflected light spot or/and the self-luminous light spot. As such, the applicability of the touch display system 100 can be significantly improved.

FIG. 4 is a schematic flow chart illustrating a touch control method of a touch display system according to an embodiment of the invention. Please refer to FIG. 4. According to the previous embodiment, the touch control method of the touch display system may include following steps. A display image is provided in step S402, and the display image can be a projected image, for instance. An invisible light curtain is generated to form a touch area in step S404, and the invisible light curtain is parallel to the display image and entirely covers the display image. Note that the touch area can be greater than or equal to the display image, for instance. An image of the touch area is captured, and at least one light spot in the touch area is detected in step S406. According to the light spot detected in the touch area when the invisible light curtain is turned on and turned off, it is determined whether the light spot in the touch area is the reflected light spot generated by the touch object through reflecting the invisible light curtain or the self-luminous light spot generated by the touch object and located in the display image. When the invisible light curtain is continuously turned on, the light spot that is located in the touch area and captured by the light detection unit is ignored. After the invisible light curtain is turned off, the light spot which is located in the touch area and captured by the light detection unit is determined in step S408. The touch object is an invisible laser pen configured to generate the self-luminous light spot, and the self-luminous light spot is an invisible light spot, for instance. In addition, the frequency of turning on and off the invisible light curtain corresponds to an image capturing frequency of the light detection unit. In particular, when the invisible light curtain is turned off, one image of the touch area is captured according to a predetermined image capturing frequency; when the invisible light curtain is turned on, plural images of the touch area are continuously captured according to the predetermined image capturing frequency. A touch location of the touch object is determined according to the light spot detected in the touch area by the light detection unit (step S410). As such, whether the detected light spot is generated from the non-self-luminous touch object or/and the self-luminous touch object can be effectively determined.

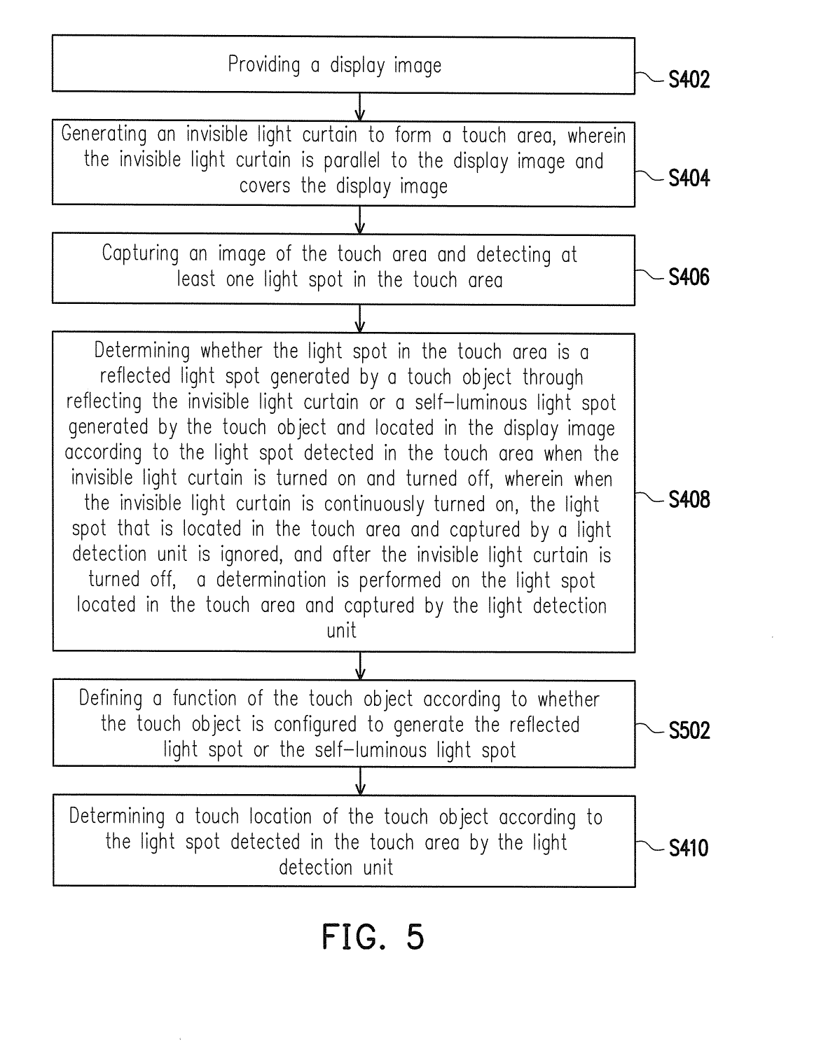

FIG. 5 is a schematic flow chart illustrating a touch control method of a touch display system according to another embodiment of the invention. The difference between the embodiment shown in FIG. 5 and the embodiment shown in FIG. 4 lies in that the embodiment shown in FIG. 5 further includes step S502; as depicted in FIG. 5, after step S408, the function of the touch object is defined according to whether the touch object is configured to generate the reflected light spot or the self-luminous light spot (step S502). For instance, the touch object capable of generating the self-luminous light spot can be defined to have the function of a painting brush, and the touch object capable of generating the reflected light spot can be defined to have the function of an eraser; however, the invention is not limited thereto. After that, in step S410, the touch location of the touch object is determined according to the light spot detected in the touch area by the light detection unit. Thereby, the function of the touch object capable of generating the self-luminous light spot and the function of the touch object capable of generating the reflected light spot can be performed on the corresponding touch locations of the display image, and thereby the applicability of the display system can be improved.

To sum up, the light spot in the touch area in the captured image is detected when the invisible light curtain is turned on and turned off, and whether the light spot in the touch area is the reflected light spot generated by the touch object through reflecting the invisible light curtain or/and the self-luminous light spot generated by the touch objects is determined. When the invisible light curtain is continuously turned on, the light spot that that is located in the touch area and captured by the light detection unit is ignored. After the invisible light curtain is turned off, the light spot that is located in the touch area and captured by the light detection unit is determined. When the light detection unit starts to detect the light spot, if the invisible light curtain is already turned off, the light spot in the touch area is directly detected. Thereby, whether the detected light spot is generated by the non-self-luminous touch object or by the self-luminous touch object can be effectively determined. According to an embodiment of the invention, the function of the touch object can be further defined according to whether the touch object is configured to generate the reflected light spot or the self-luminous light spot, and accordingly the applicability of the touch display system can be further enhanced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch display system comprising:
a display apparatus providing a display image;
an invisible light generating unit generating an invisible light curtain, the invisible light curtain being parallel to the display image and covering the display image, so as to form a touch area;
a light detection unit coupled to the invisible light generating unit, the light detection unit capturing an image of the touch area, detecting at least one light spot in the touch area, and determining whether the at least one light spot in the touch area is a reflected light spot generated by a touch object through reflecting the invisible light curtain or/and a self-luminous light spot generated by the touch object according to the at least one light spot detected in the touch area when the invisible light curtain is turned on and turned off; and
a host coupled to the light detection unit, the host determining a touch location of the touch object on the display image according to the at least one light spot detected in the touch area by the light detection unit, wherein if the invisible light curtain is continuously turned on, the at least one light spot located in the touch area and captured by the light detection unit is ignored, and after the turned-on invisible light curtain is turned off, the host performs a determination on the at least one light spot located in the touch area and captured by the light detection unit.

2. The touch display system of claim 1, wherein when the light detection unit starts to detect the at least one light spot, if the invisible light curtain is turned off, the at least one light spot in the touch area is directly determined.

3. The touch display system of claim 1, further comprising:
a control unit coupled to the invisible light generating unit and the light detection unit and configured to control the invisible light generating unit to be turned on and turned off and control an image capturing frequency of the light detection unit.

4. The touch display system of claim 1, wherein a frequency of turning on and off the invisible light curtain corresponds to an image capturing frequency of the light detection unit.

5. The touch display system of claim 4, wherein when the invisible light curtain is turned off, the light detection unit captures an image of the touch area according to the image capturing frequency predetermined by a control unit, and when the invisible light curtain is turned on, the light detection unit continuously captures a plurality of images of the touch area according to the image capturing frequency predetermined by the control unit.

6. The touch display system of claim 5, wherein whether the at least one light spot in the touch area is the reflected light spot generated by the touch object through reflecting the invisible light curtain or/and the self-luminous light spot generated by the touch object is determined according to the image captured when the invisible light curtain is turned off and the images captured when the invisible light curtain is turned on.

7. The touch display system of claim 1, wherein the light detection unit is configured to detect invisible light.

8. The touch display system of claim 1, wherein the host and the light detection unit are integrated as one apparatus.

9. The touch display system of claim 1, wherein the host defines a function of the touch object according to whether the touch object is configured to generate the reflected light spot or the self-luminous light spot.

10. The touch display system of claim 1, wherein the touch object is an invisible laser pen configured to generate the self-luminous light spot, and the self-luminous light spot is an invisible light spot.

11. The touch display system of claim 1, wherein the display apparatus is a projection apparatus and the display image is a projected image.

12. A touch control method of a touch display system, comprising:
providing a display image;
generating an invisible light curtain to form a touch area, wherein the invisible light curtain is parallel to the display image and covers the display image;
capturing an image of the touch area and detecting at least one light spot in the touch area by the light detection unit;
determining whether the at least one light spot in the touch area is a reflected light spot generated by a touch object through reflecting the invisible light curtain or/and a self-luminous light spot generated by the touch object according to the at least one light spot detected in the touch area when the invisible light curtain is turned on and turned off; and
determining a touch location of the touch object according to the at least one light spot detected in the touch area by the light detection unit,
wherein if the invisible light curtain is continuously turned on, the at least one light spot located in the touch area and captured by the light detection unit is ignored, and after the turned-on invisible light curtain is turned off, the at least one light spot located in the touch area and captured by the light detection unit is determined.

13. The touch control method of claim 12, wherein when the light detection unit starts to detect the at least one light spot, if the invisible light curtain is turned off, the at least one light spot in the touch area is directly determined.

14. The touch control method of claim 12, wherein a frequency of turning on and off the invisible light curtain corresponds to an image capturing frequency of the light detection unit.

15. The touch control method of claim 12, wherein when the invisible light curtain is turned off, an image of the touch area is captured according to the image capturing frequency predetermined by a control unit, and when the invisible light curtain is turned on, plural images of the touch area are continuously captured according to the image capturing frequency predetermined by the control unit.

16. The touch control method of claim 15, wherein whether the at least one light spot in the touch area is the reflected light spot generated by the touch object through reflecting the invisible light curtain or/and the self-luminous light spot generated by the touch object is determined according to the image captured when the invisible light curtain is turned off and the images captured when the invisible light curtain is turned on.

17. The touch control method of claim 12, further comprising:
defining a function of the touch object according to whether the touch object is configured to generate the reflected light spot or the self-luminous light spot.

18. The touch control method of claim 12, wherein the touch object is an invisible laser pen configured to generate the self-luminous light spot, and the self-lumminous light spot is an invisible light spot.

19. The touch control method of claim 12, wherein the display image is a projected image.
